(19) United States
(12) Patent Application Publication
(10) Pub. No.: US 2015/0167647 A1
(43) Pub. Date: Jun. 18, 2015

(54) CONCENTRATING SOLAR POWER PLANT WITH HYBRID COLLECTOR FIELD

(71) Applicant: Bechtel Power Corporation, Frederick, MD (US)

(72) Inventors: Seyfettin C. Gülen, Middletown, MD (US); Ralph Gerhard Zimmermann, Mill Valley, CA (US)

(73) Assignee: Bechtel Power Corporation, Frederick, MD (US)

(21) Appl. No.: 14/132,957

(22) Filed: Dec. 18, 2013

(51) Int. Cl. F03G 6/06; F24J 2/30; F24J 2/34; F24J 2/10

(52) U.S. Cl. CPC F03G 6/06; F24J 2/10; F24J 2/30; F24J 2/34; F24J 2002/1076

(57) ABSTRACT

A hybrid solar energy power plant combines solar collector technologies with different cost and performance characteristics, to exploit the advantages and mitigate the disadvantages of each technology. The synergies allow significant improvement in plant economics. Embodiments include a high concentrating solar tower plus lower concentrating linear Fresnel or parabolic trough solar energy collectors. During sunlight, the lower concentrating collector generates steam for a turbine producing electric power. The higher concentrating (hotter) collector increases the temperature of this steam and also stores thermal energy by accumulating hot molten salt. Absent sunlight, the stored energy generates steam for power and also optimizes system temperatures, such as for quick startup from a cold state. In a hybrid plant, energy storage also improves utilization of collector capacity. A programmed controller is coupled to valves, pumps and actuators among the circulation paths and heat exchangers, to manage efficient collection, storage and utilization of heat energy.

### FIELD

This invention concerns methods and apparatus that seamlessly integrate different solar energy collection technologies for high temperature and pressure steam production, especially to be coupled into a steam turbine for efficient and cost-effective electric power generation.

### BACKGROUND

Concentrating solar power (CSP) is an important part of the renewable electric power generation portfolio. Three particular CSP-enabling solar collector system (SCS) technologies are differentiated by their reflector (mirror) and absorber (receiver) types and configurations. The three main CSP-enabling solar collector system technologies are at various stages of technological maturity. They have different cost and performance characteristics.

Of those three SCS technologies, one is most technically mature, and thus has commensurate advantages such as ease of obtaining project plan approvals and project financing (“bankability”). That technology employs Parabolic Trough or PTR solar energy collection. Briefly, elongated mirror troughs in an array reflect incident solar radiation onto the path of a fluid flowing in a conduit located along a focal line in the trough. The fluid is heated by the solar radiation. The parabolic reflector shape and movable receiver increase optical efficiency. Commercial versions of PTR use synthetic oil as a working/heat transfer fluid (HTF) to absorb solar radiation and transfer the absorbed heat to steam in a heat exchanger. Synthetic oil HTF has a limited maximum operating temperature, which limits steam temperatures and steam-cycle efficiencies.

Another SCS technology is the Solar Tower or Central Receiver system (CRS). In this technology, each of numerous two-axis tracking mirrors (heliostats) in a collection field reflects incident solar energy toward a central heat collection point for the field. The centralized collection point provides the potential to reach high steam temperatures and associated high steam cycle efficiencies.

Linear Fresnel (LFR) or Compact Linear Fresnel (CLFR) is a third SCS technology. It potentially has the lowest capital cost of these three alternatives, per unit of collector area. On the other hand, CLFR has the lowest optical efficiency and is the least efficient at producing the high temperatures needed for high steam-cycle efficiency. Commercial versions of CLFR use direct steam generation (DSG), wherein the HTF is water or steam. A DSG solar collector system produces steam that can be directly coupled to drive a steam turbine that in turn drives an electric generator. A SGS that uses another HTF must use a heat exchanger to generate steam.

Thermal energy storage (TES) is an important consideration if a CSP system is to provide a reasonably continuous energy output. Solar radiation is discontinuous by its nature (weather, time of day, etc.). Thermal energy storage alleviates characteristic problems associated with intermittence and unpredictability of solar radiation, and increases the cost-effectiveness of generating equipment by increasing its utilization. Thermal energy storage thus allows a SCS to provide dispatchable power. In many commercial applications, TES has become mandatory. Molten salt is the only commercially proven thermal storage medium for the large amounts of TES needed to operate a plant during evening and into the night. Molten salt has a relatively high freezing point, which makes it more difficult to use in low concentration linear SCS such as PTR or LFR. Molten salt from a receiver can be stored in a tank and withdrawn on demand to heat steam in a steam generator/heat exchanger. Molten salt exiting the steam generator can be stored in a second tank, from which it is pumped back to the receiver.

Heated/pressurized steam is not well suited for large amounts of TES, which disadvantages a SCS using DSG, such as CLFR. Efforts are underway to develop alternatives that might facilitate TES, such as a molten salt CLFR technology, but this technology is immature.

Of the three candidate technologies, CRS is most suited for large scale TES. It provides the high temperatures that can most cost-effectively use molten salt and has been proven using molten salt directly as HTF; i.e., with molten salt being heated directly in a central receiver.

Parabolic trough receivers can accommodate TES if additional equipment and piping are provided for heat exchange between the synthetic oil HTF and the heat energy storage medium (molten salt). Synthetic oil has a lower maximum operating temperature than molten salt, which increases the amount of molten salt required and the cost of associated materials and equipment. The additional complexity and investment increase the installation and operational costs of the final system so significantly that PTR with TES is less cost-effective than CRS, especially for the amounts of TES needed to operate a plant for longer periods.

The amount of solar energy incident on a solar field inherently varies during the day, from zero at daybreak to a maximum at solar noon, to zero at sunset. The amount of incident solar energy also varies by season. The form of solar energy usable by a CSP system is termed “direct normal insolation” (DNI), which is necessary for an SCS collector to focus radiation onto a receiver, where the HTF is heated. The SCS collector field and receiver are optimally sized so that they can deliver a design flow rate of HTF for a large portion of the year. For some portion of the year, this will result in a certain amount of capacity in excess of that needed to provide the design flow rate (“oversizing”). This excess capacity can generally not be used for generation of steam and power. Due to its low solar field capital cost, yet low optical efficiency, CLFR has the highest optimal oversizing.

It might be possible to make trade-offs and selections among the available technologies, e.g., to choose CRS for high steam temperature and suitability for TES, or to choose CLFR for low capital cost even though adding heat energy storage may be impractical and thus power generation will effectively be limited to periods of sunlight. According to the present invention, techniques are provided to merge plural SCS technologies in an efficient and optimized manner, so as to exploit their advantages while avoiding unnecessary duplication and undue cost.

### SUMMARY

It is an object of this disclosure to optimally combine the favorable characteristics of plural different SCS technologies. Another object is to exploit aspects of different SCS technologies in a way that will be accepted by project developers and financing institutions as relying on demonstrably workable parts operating in an integrated manner under defined controls.

An ultimate goal in renewable power generation in general and CSP in particular is to produce a high annual electrical output, to do so while minimizing capital and operating expenditures, and to provide these advantages without sacrificing system availability and reliability. One of the three candidate technologies, namely CRS, is operationally proven, allows high temperatures and associated high steam cycle efficiencies, and has the ability to cost-effectively provide high storage capability (TES). It is an aspect of the invention to produce two hybrid collector systems. One is a hybrid of CRS and CLFR. The other is a hybrid of CRS and PTR. One inherent advantage of such hybrid systems is the ability to cost effectively use the excess energy from oversizing of the CLFR or PTR solar fields, by displacing energy that would otherwise be extracted from the CRS thermal energy storage, allowing the TES energy to be used later and thereby increase total generation. The CRS/CLFR arrangement allows superheating of steam from the CLFR system by using heat exchangers required by the CRS system during nighttime operation, increasing their utilization.

Hybrid SCS variants have been proposed as concepts. (See, Han, W. et al., 2012, “A Novel Concentrated Solar Power System Hybrid Trough and Tower Collectors,” GT2012-68991, ASME IGTI Turbo Expo 2012, Jun. 11-15, 2012, Copenhagen, Denmark; Goffe, D. et al., 2009, “The Benefits of Coupling a Linear Fresnel Field with an Overheating Central Receiver,” SolarPACES 2009, 15-18 Sep. 2009, Berlin, Germany; and, Augsburger, G., 2013, “Thermo-economic optimization of large solar tower power plants,” Thesis Nr. 5648 (2013), École Polytechnique Fédérale De Lausanne.) However, an aim of the current invention is to improve and to make combined SCS technologies feasible for reliable and reasonably continuous electric power generation.

The present invention differs from hybrid concepts as disclosed in the foregoing disclosures, in at least two important aspects: (1) Direct contribution (“injection”) of superheated (as opposed to saturated) steam from the CLFR or PTR (to the extent possible), and (2) An optimized system for stable control of the hybrid collector with the storage system. The present system thus is superior to proposed hybrids such as the system of Goffe, D. et al., described in the 2009 SolarPACES publication cited above. A theoretical comparison against Goffe, across the entire annual solar irradiation profile from hour-by-hour simulation, appears below in Table I.

TABLE I

| | Goffe et al. | Present Invention |
|---|---|---|
| Net Rating | 50 MWe | 50 MWe |
| Solar Collector System | CLFR + CRS | CLFR + CRS |
| Total Collector Area | Base | +20% |
| Total Electricity Production | 91 GWhe | 177 GWhe |
| Capacity Factor | 20% | 40% |
| Thermal Storage | None | 4 hours |
| Solar-to-Electric Efficiency | 8.9% | 12.6% |

According to these and other aspects, a hybrid solar energy power plant is disclosed herein, combining solar collector technologies with different cost and performance characteristics, so as to exploit the advantages and mitigate the disadvantages of each technology. The synergies allow significant improvement in plant economics. Embodiments include a high concentrating solar tower plus lower concentrating linear Fresnel or parabolic trough solar energy collectors. During sunlight, the lower concentrating collector generates steam for a turbine producing electric power. The higher concentrating (hotter) collector increases the temperature of this steam and also stores thermal energy by accumulating hot molten salt. Absent sunlight, the stored energy generates steam for power and also optimizes system temperatures, such as for quick startup from a cold state. In a hybrid plant, energy storage also improves utilization of collector capacity. A programmed controller is coupled to valves, pumps and actuators among the circulation paths and heat exchangers, to manage efficient collection, storage and utilization of heat energy.

Accordingly, particular SCS hybrid configurations are disclosed as optimal, and are operable under accompanying control philosophies that support operations in a wide envelope of site ambient and loading conditions.

### Acronym Glossary

CLFR=Compact Linear Fresnel
CRS=Central Receiver (Solar Tower) System
CSC=Concentrating Solar Collector
DSG=Direct Steam Generation
HTF=Heat Transfer Fluid
PTR=Parabolic Trough
SCS=Solar Collector System
TSS=Thermal Storage System

### BRIEF DESCRIPTION OF THE DRAWINGS

The invention is disclosed herein and shown in drawings that demonstrate particular arrangements as examples. It should be understood that the invention is capable of other specific arrangements within this disclosure and accompanying claims. In the drawings,

FIG. 1 is a block diagram showing the major elements of a hybrid solar collector power generation system according to this disclosure.

FIG. 2 is a schematic diagram showing according to an embodiment using direct steam generation in a solar field (e.g., with linear Fresnel collectors). The collection, heat exchange and energy extraction elements are shown coupled by flow paths for heat transfer fluid and water/steam.

FIG. 3 is a schematic diagram showing according to an alternative embodiment using heat transfer fluid heating in a solar field (e.g., with a parabolic trough receiver).

### DETAILED DESCRIPTION OF EXEMPLARY EMBODIMENTS

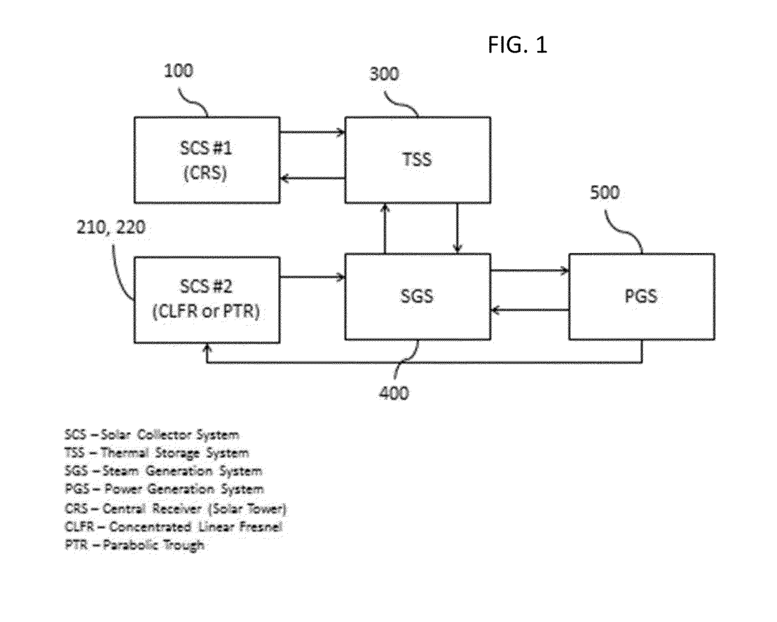

According to this disclosure and as shown in FIG. 1, two SCS technologies with different configurations are coupled into a hybrid arrangement for producing electric power via a power generation system comprising one or more steam turbines and electric generators. One solar energy collection component 100 uses a central receiver such as a solar tower (CRS) as a solar collection system (SCS), and is coupled through a thermal storage system TSS 300 to the steam generator system 400, so as to facilitate thermal energy storage as well as application of heat energy to generate steam. The steam is coupled to a power generation system PGS 500 that can have one or more steam turbines coupled to apply torque to one or more electric generators to produce electric power.

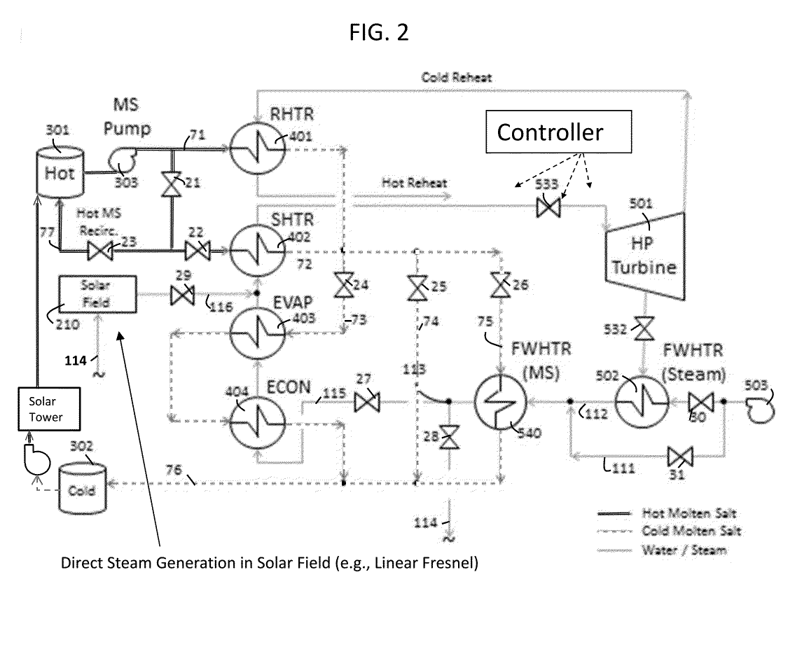

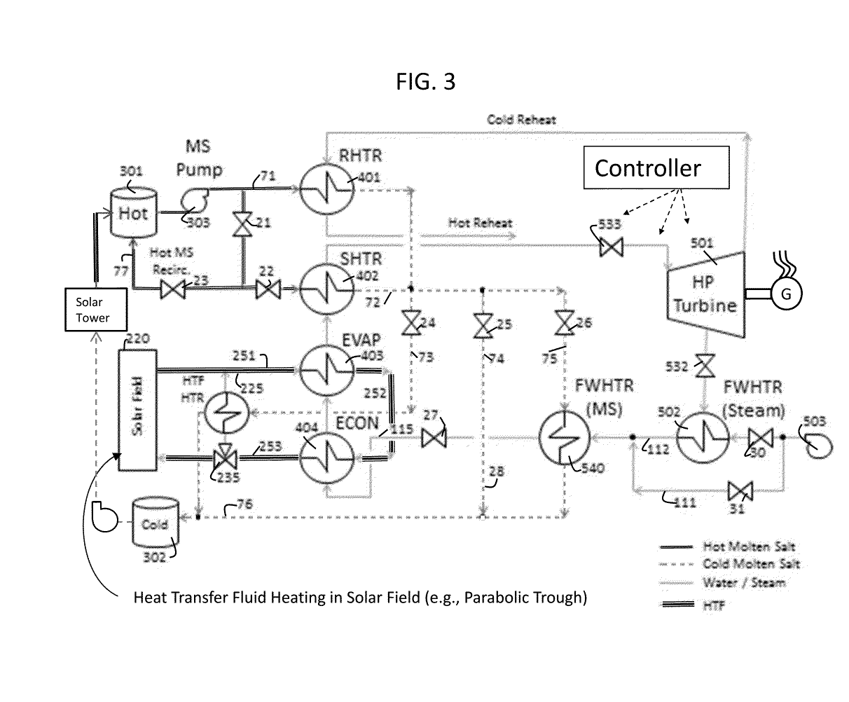

FIGS. 2 and 3 compare two alternative embodiments of the system, in which the CRS solar collector system is employed in hybrid solar field SCS arrangements, in particular with linear Fresnel and/or compact linear Fresnel (CLFR) collectors or with parabolic trough (PTR) solar receivers and collectors that can use synthetic oil heat transfer fluids.

The steam generation system (SGS) 400 is configured in a way to accommodate the two separate SCS systems and the high temperature feed water heaters of the steam turbine. This configuration seeks to achieve maximum controllability of the temperatures of circulating water, steam and molten salt (and/or other heat transfer fluid if present) under all operating conditions, including transient conditions such as startup and up/down ramps.

A first configuration, shown schematically in FIG. 2, is based on CRS and CLFR (or another DSG system) technologies. The SGS comprises four molten salt heat exchangers 401 through 404. These heat exchangers are for preheating (economizing in technical jargon) water 404, generating steam (evaporator 403) and for superheating and for reheating steam 402, 401. Steam (saturated or superheated) generated in the CLFR receiver 201 in the solar field is injected into the SGS at suitable locations along the process flow and at programmed conditions of temperature matching and performance, by operation of respective control valve components (recirculating, bypassing and feed water heating) to adjust molten salt flow and return temperature for optimal performance. The valves are controlled by a programmed controller (not shown) in a control protocol that is responsive to available solar radiation and current temperatures and pressure conditions.

A second configuration, shown schematically in FIG. 3, is based on CRS and PTR (or another HTF system) technologies. The same reference numbers are used in FIG. 3 as in FIG. 2, to identify comparable elements. The SGS comprises HTF heat exchangers for preheating/economizing water and generating steam (evaporator) in addition to molten salt heat exchangers for superheating/reheating steam. HTF heated in the PTR receiver 220 in the solar field is used in the SGS when the PTR system is fully on. When the PTR system is off and the CSP plant is run with molten salt from the TSS, molten salt is utilized to heat the HTF in a separate heat exchanger 225. The control methodology likewise comprises valve components (controlling recirculating, bypassing and feed water heating) to adjust molten salt flow and return temperature for optimal performance.

In reviewing this disclosure and when considering the illustrations in the drawings, various elements are shown or described as being connected or coupled. Unless otherwise stated or apparent, connections and couplings are intended to denote operational relationships and to encompass connections or couplings that are direct as well as through intervening elements or through elements that may be opened or closed in different phases of operation, such as valves.

Referring more specifically to FIG. 1, the CSP plant, shown generally, comprises two SOS's 100 and 210 or 220 and TSS 300. Solar energy is collected in each SCS and coupled by means of flow paths, valves and heat exchangers to SGS 400 to generate steam. The steam is coupled for electric power generation in the PGS 505, which includes at least one steam turbine coupled to an electric generator (for example as shown in FIG. 2). The SCS #1 in this block diagram is shown as used to charge the TSS. The solar energy transferred to the TSS is transferred to the SGS via TSS discharge. Alternative arrangements are also possible, for example wherein control valves and flow paths are provided to bypass the TSS, for use, for example, if the TSS is brought to storage capacity and SCS #1 can then be coupled operationally to SGS 400 for contributing to the production of steam as opposed to thermal storage. Solar energy from the SCS #2 is coupled to the SGS 400 for generation of steam.

An operational mode is described below with both SOS's 100 and 210 or 220 collecting solar energy and the TSS 300 discharging heat to SGS 400. Likewise, SCS 100 can be on while SCS 210 or SCS 220 is off, in which case SGS 400 receives heat energy from TSS 300 while TSS 300 is receiving heat energy from SCS 100. In the absence of active solar energy collection, SGS 400 can be operated from TSS 300 alone.

In FIG. 2, during a normal operating mode wherein with SCS #1 (100) and SCS #2 (210) are both collecting solar energy (for example at midday when the sun is shining and the system is operating at full solar collection capacity), hot molten salt from a hot molten salt supply such as tank 301 is pumped by a variable speed molten salt pump 303. Part of the pumped hot salt goes along conduit 71 through the reheat superheater 401 to heat the cold reheat steam from the exhaust of HP turbine 501. Part of the pumped hot salt 72 goes through the valves 21 and 22 to the superheater 402 to heat the saturated or somewhat superheated steam from conduit 116 from the solar field 210 via valve 29. The steam from solar field 210 through conduit 116 is mixed with a small amount of steam from the evaporator 403.

A recirculation valve 23 is modulated by the controller as needed to return a portion of the hot molten salt, namely along stream 77, from the pump 303 discharge back to the tank 301. This serves two purposes:
1. Pump 303 is operated at or near the optimal head-flow point, and,
2. The temperature of the cold molten salt return is controlled (in combination with the pump speed/flow rate).

Combined molten salt streams from the heat exchangers RHTR 401 and SHTR 402 are divided into three streams that flow through conduits 73, 74 and 75, controlled by the valves 24, 25 and 26, respectively. For example, molten salt flow at conduit 73 can be coupled through valve 24 into the evaporator heat exchanger EVAP 403 and then through the economizer (preheater) heat exchanger ECON 404 in series, and then returned to the cold salt storage tank 302. Molten salt flow through conduit 73 can be as low as a “trickle” flow to keep heat exchangers 403 and 404 (EVAP and ECON) warm at minimum duty operation. Otherwise it is modulated to maximize steam turbine output and utilization of SCS #2 (210) and minimize the depletion rate of molten salt level in the hot molten salt tank 301.

Molten salt stream 75, controlled by valve 26, goes through the high pressure feed water heater heat exchanger FWHTR MS 540 and heats cold feed water from the boiler feed pump 503 with suction from the de-aerating (open) feed water heater of the steam turbine (not shown). This arrangement serves two purposes:
1. Improved steam turbine performance due to the fact that steam, otherwise used to heat the cold feed water, is now used for power generation in downstream turbine sections. During normal operation, feed water heat exchanger FWHTR (steam) 502 is out of service. Valves 532 and 30 are closed; valve 31 is open, bypassing along conduit 111 to conduit 112.
2. Molten salt energy is spent (for a useful purpose) with the ultimate effect of reducing the combined cold molten salt return temperature.

The remainder of the molten salt flow from SHTR 402 through conduit 72 (if any), is coupled through valve 25 to conduit 74 and bypasses the heat exchangers 403, 404 and 540 (EVAP, ECON and FWHTR MS). The three return molten salt streams, 73, 74 and 75 combine at flow conduit 76 and return to the cold molten salt tank 302.

During a TSS discharge operation with SCS #1 (100) on and SCS #2 (210) off (for example in the evening), heat exchangers 401, 402, 403 and 404 use the heat from molten salt to generate steam. Valves 23, 28 and 29 are closed. Valve 26 is either closed with heat exchanger 540 out of service or is partially open with heat exchanger 540 in service for supplementary feed water heating.

Feed water heating slack is picked up by the regular feed water heater 502. Valves 532, 30 and 31 are modulated to ensure appropriate extraction steam and feed water flows.

A distinct operational sequence is managed for start-up operation. During startup in the morning, the steam turbine is started in TSS discharge mode. All requisite rolling, from turning gear to full speed no load (FSNL), temperature matching, loading to full speed full load (FSFL) via steam flow and pressure control requirements are observed in accordance with steam turbine manufacturer requirements.

The controller adjusts molten salt flow through heat exchangers 401, 402, 403 and 404 including bypass and recirculation flows via requisite valves (all mentioned earlier in conjunction with normal/discharge operation descriptions and shown in FIG. 2). Steam temperature control via attemperation (de-superheating) flows and requisite valves (typically diverting feed water flow from the boiler feed pump 503 discharge or inter-stage extraction ports) are not shown explicitly. However, they are readily applied by those skilled in the art and do not constitute an integral part of the current invention.

During the startup of the entire CSP plant, an undesirable factor is the time required for warming up the solar field 210. In the morning, especially during winter months, warm-up to operational temperatures might take 2 to 3 hours. Reduction in this solar-driven warm-up period is desirable because power generation time and the plant capacity factor can be improved, possibly substantially if the warm-up time is minimized. The plant power generation time and capacity are important drivers of CSP feasibility.

According to one aspect, the time needed for warm-up can be reduced by heating the feed water in the molten salt heater 540 with the extraction steam feed water heater 502, also in service. The hot feed water from the heat exchanger 540, stream 114, is diverted to the SCS 210 via valve 28. This circulates hot feed water through the receiver tubes of SCS 210 in the solar field and speeds the warming up process. Since the bulk of this warm-up operation coincides with the steam turbine startup (possibly for up to about one hour), no significant power generation loss accompanies this procedure.

An alternative embodiment is shown in FIG. 3, which uses the same reference numbers as FIG. 2 to refer to comparable elements. During normal operation with SCS #1 (100) and SCS #2 (220) both on (for example at midday when the sun is shining), hot molten salt from the hot molten salt tank 301 is pumped by the variable speed molten salt pump 303. Part of the pumped hot salt 71 goes through the reheat superheater 401 to heat the cold reheat steam from the HP turbine exhaust. Part of the pumped hot salt 72 goes through the valves 21 and 22 to the superheater 402 to heat the saturated or somewhat superheated steam from the evaporator 403 (much as previously described with reference to FIG. 2).

Recirculation valve 23 is modulated by the controller as needed to return a portion of the hot molten salt, stream 77, from the pump 303 discharge back to the tank 301.

In this embodiment, the solar collection system SCS 220 in the solar field heats a heat transfer fluid HTF, flowing in a distinct flow loop delineated by a wide line along conduits 251, 252, 253 and heat exchangers EVAP 403 and ECON 404 (pump not shown). Evaporator EVAP 403 generates steam in the water/steam flowpath 115, using heat from hot HTF 251 flowing from SCS 220. HTF in conduit 252 from the evaporator discharge is used to economize (preheat) the feed water from flowpath 115, in the economizer 404. Cold HTF returns to SCS 220 via conduit 253 and three-way HTF valve 235.

Cold molten salt (dashed line conduits) from heat exchangers 401 and 402 flows primarily through valve 26 and heats the feed water in heat exchanger FWHTR (MS) 540. A trickle flow 73 may be provided to flow through valve 24 to keep the HTF heater 225 warm. Otherwise, it is modulated as described above to optimize steam generation and power production. The remaining cold molten salt, at stream 74, bypasses the heat exchangers via valve 25. All three return molten salt streams, 73, 74 and 75 combine into stream 76 and flow into the cold molten salt tank 302.

During a TSS heat discharge operation, assuming that SCS #1 (100) is on and solar field SCS #2 (220) is off (for example in the evening), three-way valve 235 diverts cold HTF at conduit 253 to the molten salt HTF heater 225. (Although shown as a single heat exchanger in FIG. 3, in an alternative embodiment, HTF 224 can comprise multiple parallel heat exchangers to optimize system design.) Valve 24 is modulated by the controller to provide enough molten salt flow, along stream 73, through the HTF heater 225 for maintaining temperature conditions.

Valves 25 and 26, along with the recirculation flow control valve 23, are modulated to control the cold molten salt, stream 76, return temperature.

Feed water heating slack is picked up by the regular feed water heater 502. Valves 532, 30 and 31 are modulated to ensure appropriate extraction steam and feed water flows.

As described herein, the invention concerns a solar energy concentrating power plant with at least two solar energy collection arrangements in hybrid configuration wherein a highly concentrating solar collection system is operated to store heat in a heat storage facility, a lower concentrating and lower temperature solar collection system operates contemporaneously with the highly concentrating solar energy system and is used when sunlight is present to generate electrical power. A controller is coupled to circulating fluid paths for the respective solar energy collection and heat energy storage and energy extraction and conversion apparatus, and operates valves, pumps and other actuators to manage efficient collection and exploitation of the heat energy.

Accordingly, the power plant of the invention includes a first solar collection arrangement having a first set of plural reflectors grouped to direct solar radiation incident on the first set of reflectors, onto at least one concentrating solar energy collection apparatus, whereby a high heating temperature is achieved at the concentrating solar energy collection apparatus during sunlight conditions. A second solar collection arrangement having a second set of plural reflectors is arranged to direct solar radiation incident on the second set of reflectors, onto at least one lower concentrating solar energy collection apparatus during sunlight conditions, whereby a heating temperature lower than the first heating temperature is achieved. A heat storage facility controllably receives and stores heat energy, and extract from storage and discharges heat energy, normally to generate electric power but also, during some modes of operation including startup, to bring portions of the plant up to optimal operating temperatures. A power extraction system is configured to extract useful energy from heat, especially a steam turbine coupled to an electric generator. An array of coupling conduits, pumps and control valves responsive to a controller, are operable during sunlight conditions to move heat energy from the highly concentrating solar energy collection zone into the heat energy storage apparatus, and to operate the power extraction system to extract useful energy from the lower concentrating solar energy collection zone.

The controller is operable during at least one of non-sunlight and startup conditions to extract and discharge stored heat energy from the heat storage facility. This can be to extract heat energy as steam for power generation, so that the electric power output of the plant can be continuous through times of low or nonexistent sunlight. The energy extraction can also be by transfer of heat energy, through heat exchangers, or where appropriate by routing flows of warm heat transfer fluid.

The first solar collection arrangement, namely the highly concentrating collector, can include a receiver and an array of heliostat mirrors directing the sunlight onto the receiver. For example, a central receiver can be located in a solar field and comprises a solar tower.

The second solar collection arrangement comprises a fluid circulation path forming the lower concentrating solar energy collection apparatus. In one embodiment, the fluid circulation path of the second solar collection arrangement carries at least one of water and steam and operates as a direct steam generator.

The second solar collection arrangement can include one or more of linear Fresnel collectors, compact linear Fresnel collectors and parabolic trough reflectors, etc. At least part of the second solar collection arrangement can be configured for direct steam generation for producing at least one of saturated steam and superheated steam in the collectors. The directly generated steam is routed through valves and conduits to a steam turbine coupled to an electric generator.

In another embodiment, the fluid circulation path of the second solar collection arrangement can be arranged to carry a heat transfer fluid. In that case, at least one heat exchanger couples heat energy from the heat transfer fluid to a steam generator producing steam flowing to the power extraction system, which has at least one steam turbine coupled to an electric generator.

In some embodiments, the first solar collection arrangement (the highly concentrating collector) and the heat storage facility use a same working fluid, such as molten salt. In that case, advantageously, the heat storage facility can store heat energy by accumulating the working fluid after the working fluid has been heated by the first solar collection arrangement. The stored inventory of heat energy varies with the temperature and volume of heated working fluid in storage.

The plant is operated by a controller that controls flows using pumps and valves that are on/off and/or proportionally controlled as a function of temperature and sunlight conditions. The controller may be coupled to suitable sensors for determining operational temperatures, incident sunlight amplitude, available heat storage volume and temperature. The controller advantageously can be operable during a startup phase of operation to transfer heat energy from the heat storage facility to the fluid circulation path, particularly to warm up the lower concentrating solar collection system during a startup sequence, to enhance efficiency and the operational time of the plant.

The invention has been disclosed in connection with certain exemplary embodiments. It should be appreciated that the invention is not limited to the arrangements, configurations and embodiments disclosed as examples, and is capable of variations within the scope of the appended claims. Reference should be made to the appended claims, and not to the disclosure of exemplary embodiments, to assess the scope of the invention in which exclusive rights are claimed.

What is claimed is:

1. A solar energy concentrating power plant comprising:
a first solar collection arrangement having a first set of plural reflectors grouped to direct solar radiation incident on the first set of reflectors, onto at least one highly concentrating heat energy collection apparatus, whereby a high heating temperature is achieved at the concentrating solar energy collection apparatus during sunlight conditions;
a second solar collection arrangement having a second set of plural reflectors arranged to direct solar radiation incident on the second set of reflectors, onto at least one lower concentrating solar energy collection apparatus during sunlight conditions, whereby a lower heating temperature is achieved at the lower concentrating solar energy collection apparatus that is lower than the high heating temperature achieved at the concentrating solar energy collection apparatus;
a heat storage facility configured controllably to receive and store heat energy, and to extract from storage and to discharge heat energy;
a power extraction system configured to extract useful energy from heat; and,
an array of coupling conduits, pumps and control valves responsive to a controller, operable during sunlight conditions to move heat energy from a zone of the highly concentrating heat energy collection apparatus into the heat energy storage apparatus, and to operate the power extraction system to extract useful energy from a zone of the lower concentrating solar energy collection apparatus;
wherein the controller is operable during at least one of non-sunlight and startup conditions to extract and discharge stored heat energy from the heat storage facility.

2. The power plant of claim 1, wherein the first solar collection arrangement comprises a receiver and an array of heliostat mirrors directing the sunlight onto the receiver.

3. The power plant of claim 2, wherein the central receiver comprises a solar tower.

4. The power plant of claim 1, wherein the second solar collection arrangement comprises a fluid circulation path forming the lower concentrating solar energy collection apparatus.

5. The power plant of claim 4, wherein the fluid circulation path of the second solar collection arrangement carries at least one of water and steam and operates as a direct steam generator.

6. The power plant of claim 5, wherein the second solar collection arrangement comprises at least one of a linear Fresnel collector, a compact linear Fresnel collector and a parabolic trough reflector.

7. The power plant of claim 6, wherein at least part of the second solar collection arrangement is configured for direct steam generation for producing at least one of saturated steam and superheated steam.

8. The power plant of claim 4, wherein the fluid circulation path of the second solar collection arrangement carries a heat transfer fluid.

9. The power plant of claim 5, further comprising at least one heat exchanger coupling heat energy from the heat transfer fluid to a steam generator.

10. The power plant of claim 4, wherein the power extraction system comprises at least one steam turbine coupled to an electric generator.

11. The power plant of claim 1, wherein the first solar collection arrangement and the heat storage facility use a same working fluid.

12. The power plant of claim 9, wherein working fluid comprises molten salt.

13. The power plant of claim 9, wherein the heat storage facility stores heat energy by accumulating the working fluid after heating by the first solar collection arrangement.

14. The power plant of claim 4, wherein the controller is operable during a startup phase of operation to transfer heat energy from the heat storage facility to the fluid circulation path.
